(19) United States
(12) Patent Application Publication
(10) Pub. No.: US 2009/0055200 A1
(43) Pub. Date: Feb. 26, 2009

(54) IDENTIFYING AND VALIDATING FACTORS THAT HAVE PARTICULAR EFFECTS ON USER BEHAVIOR

(75) Inventors: Sajjit Thampy, Sunnyvale, CA (US); Daniel Ferrante, Redwood City, CA (US); Amr Awadallah, Palo Alto, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 11/841,558

(22) Filed: Aug. 20, 2007

(51) Int. Cl. G06Q 99/00

(52) U.S. Cl. 705/1

(57) ABSTRACT

Techniques are described herein for an automatic discovery and validation analyzer that identifies factors that have a particular effect on members of a population in engaging in certain activities. A baseline set and a divergent set of members of the population are identified based on whether a member has experienced a significant change in magnitude of the particular effect during a particular period of time. Differences in behaviors of members of the baseline and divergent sets are then analyzed to identify a candidate factor that corresponds to exposure to an item. Such a candidate factor is then validated as to whether it is a cause of said significant change in magnitude of the particular effect experienced by the divergent set of members.

### FIELD OF THE INVENTION

The present invention relates to determining factors that have a particular effect on members of a population in engaging in certain activities, and in particular, to automatically determining factors that have a particular effect on members of a population.

### BACKGROUND

There could be many contributing factors that might have effects on people's behaviors. Take, for example, a specific activity of accessing the Yahoo! Answers pages. How often users engage in this activity may vary from time to time. Some users may increase their engagement over a time period while other users may decrease the engagement in the same period. Still other users may hardly alter their levels of engagement throughout the same period. Whether users change their “intensities of engagement” or not, it is not obvious to tell what particular factors, among a potentially infinite number of possible factors, actually have effects or impacts on how intensely users may engage in the specific activity. User behaviors may, for example, be influenced by where the Yahoo! Answers hot link on the homepage of the Yahoo! website is placed, or by an email-based advertisement campaign, or by an intermediate activity such as satisfactorily purchasing an item as a result of reading several helpful recommendations in answer pages.

Under some techniques, each of multiple web pages may be individually ranked by an aggregate number of clicks on various hot links embedded within such a web page. A web page that has a high number of clicks on its embedded links may be considered as highly impacting. Such a web page may consequently be considered a good place to direct users to a specific set of target web pages. While this intuitive approach produces some plausible guesses, these guesses may not be correct. For example, a homepage of a website may generate numerous clicks on its embedded links. However, many of these clicks may simply be related to regular access patterns that hardly represent any changes in the intensities of engagement of users with respect to any set of web pages. For instance, users may merely use the homepage as a launching pad without ever noticing other links that have popped up elsewhere on the page. Furthermore, even where visits (as including clicks from the home page) to a specific set of web pages linked in the homepage are increasing, the increase may not indicate increasing intensities by the existing users, but may rather be simply caused by a general increasing number of new users.

Thus, a need exists for improved ways of identifying factors that have a particular effect on members of a population in engaging in certain activities.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example system, according to an embodiment of the present invention;

FIG. 2 is a block diagram that illustrates an example automatic discovery and validation analyzer, according to an embodiment of the present invention;

FIG. 3 is a diagram that illustrates example entities that may be involved in a correlation analysis, according to an embodiment of the present invention;

FIG. 4 is a diagram that illustrates example entities that may be involved in a causation analysis, according to an embodiment of the present invention;

FIG. 5A and FIG. 5B are flow diagrams that illustrate an example flow of automatic discovery and validation process, according to an embodiment of the present invention; and

FIG. 6 is a block diagram that illustrates a computer system upon which embodiments of the invention may be implemented.

### DETAILED DESCRIPTION OF THE INVENTION

A method and apparatus for identifying factors that have a particular effect on members of a population in engaging in certain activities is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

In accordance with some embodiments, an automatic discovery and validation analyzer analyzes user behaviors over an extended time period, to (a) identify well-defined candidate factors that may exert impacts on user behavior changes, and (b) verify whether any of the well-defined candidate factors does exert an impact on user behavior changes. A candidate factor may be, but is not limited to, an online campaign occurring during a certain period.

In some embodiments, the analyzer combines two processes, namely an automatic discovery process and a validation process, into a single unified process that can be repeatedly executed to identify and validate impacting factors (or causes) from a very large number of possible factors. During the automatic discovery process, the analyzer identifies, from a seemingly bewildering set of possible influencing factors, a set of candidate factors as being the most likely factors for causing a specific type of user behavior change. As used herein, the term “candidate factors” refers to factors that are selected as candidates for validation. In general, the candidate factors are selected based on a determination that they are more likely to be truly impacting factors than other factors that are not identified as candidate factors.

The candidate factors determined during the discovery process are then fed into a validation process. The validation process analyzes, in (statistical) detail, whether a particular candidate factor is indeed a cause of the user behavior changes. In some embodiments, the validation process may be done in a manner that filters out general trends of user behavior changes. Such overall trends may be caused by many confounding factors, such as seasonality, interferences from other factors, etc. For example, Christmas shopping season may produce a different overall access pattern or trend than a summer vacation season on web accesses.

All or a part of the causation and correlation analysis may be repeated iteratively or recursively, in order to automatically perform various types of analyses in various details against a myriad of possible influencing factors.

Once a truly impacting factor (or cause) is identified, exposure to the factor by a user population may be increased or decreased, depending on whether the specific type of user behavior change is desired or not.

### Example System

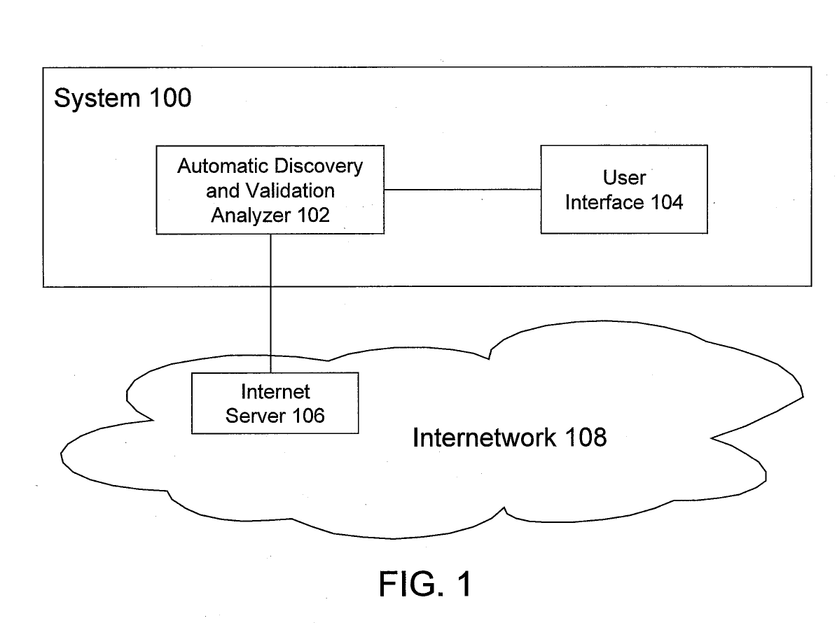

As shown in FIG. 1, the system 100 comprises an automatic discovery and validation analyzer 102, a user interface 104, and an internet server 106 that is part of an internet 108. As illustrated in FIG. 1, the automatic discovery and validation analyzer (102) has one or more communication links with the internet server (106). These communication links may be of a variety of different physical interfaces or speeds or distances (LAN, metro, WAN, etc.). Through the communication links, the automatic discovery and validation analyzer receives measurement data from the internet server (106). The measurement data may include, but is not limited to, raw web page access data, processed web page access data, web site configuration data, web page information, etc. For example, the measurement data may include page view data related to a specific user, a user terminal as represented by a specific cookie or a specific physical address (e.g., Ethernet address). The data from the internet server (106) may be collected automatically from time to time. The data may be collected on demand or by polling. The data may also be spontaneously emitted by the internet server (106), if so configured. Apart from the data collected from the internet server (106), other sources of data other than the internet server (106) may also be collected by, or provided to, the automatic discovery and validation analyzer (102).

The user interface (104) may be used by the system to receive input for any parameters, thresholds, or any adjustments of any parameters and thresholds configured for the automatic discovery and validation analyzer (102). The user interface (104) may also be used to render or display the results of analyses from the automatic discovery and validation analyzer (102).

As illustrated in FIG. 1, the user interface (104) may be connected to the automatic discovery and validation analyzer (102) through a communication link. In some embodiments, the user interface (104) may be a directly attached device to the system (102) that implements the automatic discovery and validation analyzer (102).

### Example Automatic Discovery and Validation Analyzer

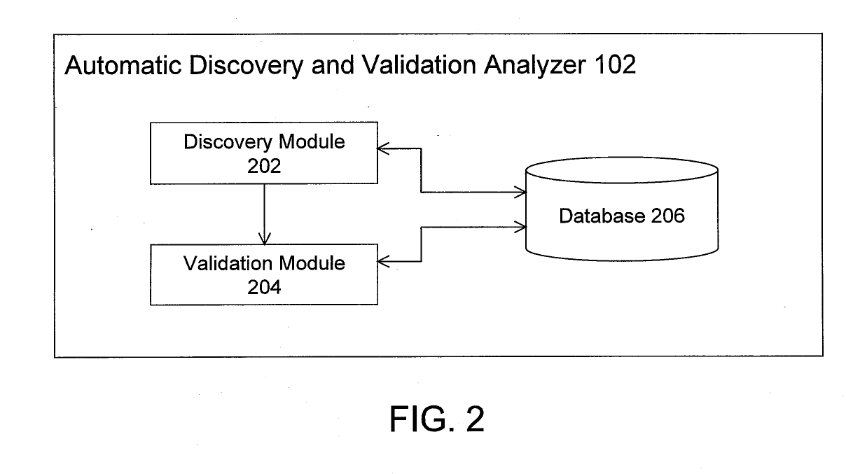

As shown in FIG. 2, the automatic discovery and validation analyzer comprises a discovery module 202, a validation module 204, and a database 206 that is operatively coupled to the automatic discovery and validation analyzer. In an alternative embodiment, the database (206) may be implemented as a separate subsystem outside the automatic discovery and validation analyzer (102). In some embodiments, the database (206) (and data therein) can be accessed by the discovery module (202) and the validation module (204). The data includes the previously mentioned data collected from the internet server (206) and other types of data that may or may not have been previously mentioned.

For example, the discovery module (202) can retrieve data stored in the database (206) and store results in the same. Likewise, the validation module (204) can also retrieve data stored in the database (206) and store results in the same.

In some embodiments, a number of candidate factors may be identified by the discovery module (202) based on its correlation analysis of the data retrieved from the database (206). These candidate factors may be inputted into and be tested by the validation module (204) to determine whether they are truly factors that have particular effects on user behaviors and, if so, to what extents they affect the user behaviors.

### The Discovery Process

According to one embodiment, during the discovery process, the analyzer is not given any specific factors to study, but rather is given a potentially large amount of data in order to identify a number of candidate factors that may exert impacts on user behavior changes. For example, the analyzer may be given a large amount of web log data that contains access statistics to hundreds, thousands, millions or more of web pages by a large user population over an extended period, for example, three months or half a year.

For example, in some embodiments, the discovery process may study a user population in during a monitoring period during which the user population is exposed to a set of potentially influencing factors. To identify candidate factors, the discovery process may consider user behavior within three distinct sub-periods of the monitoring period. The three distinct sub-periods are referred to herein as: a qualifying period, a pre-qualifying period (which occurs before the qualifying period), and a post-qualifying period (which occurs after the qualifying period).

The monitoring period may be any duration. The duration of the monitoring period may vary, for example, based on the specific behavior being monitored. For the purpose of explanation, it shall be assumed that the monitoring period is three months. Similarly, the three sub-periods within the monitoring period may be any duration, and may even overlap. For example, with a three-month monitoring period, each of the three sub-periods may be a week, a month, or any other length of time, as appropriate.

According to one embodiment, the candidate factors are determined by identifying (a) a divergent set of users and (b) a baseline set of users, from the user population, based on user behavior during the monitoring period. The divergent set of users includes users who exhibit a particular type of user behavior change. The baseline set of users, on the other hand, includes users who fail to exhibit such a behavior change. Data collected for these two sets of users, relative to exposure to possible factors, may be analyzed quantitatively (for example, how many times a user is exposed to a particular web page in the qualifying period) and qualitatively (for example, what type of exposure has a user been exposed to in the qualifying period: asking a question, searching for an answer, viewing contents, etc.). For example, in the exposure data, one may determine a set of inflection point at which the two sets of users behave differently with respect to some candidate factors (which, for example, may correspond to access to some distinct web pages in the qualifying period). For the purpose of illustration, based on the analysis on the exposure data, the divergent set of users may be found to have exposed to a particular web page much more than the baseline set of users in the qualifying period.

At the end of the analysis performed by the automatic discovery process, a set of candidate factors may be produced. As noted, these candidate factors may be best shots for causing a specific type of user behavior changes and thus may be further validated to determine whether they are truly impacting factors.

### Correlation

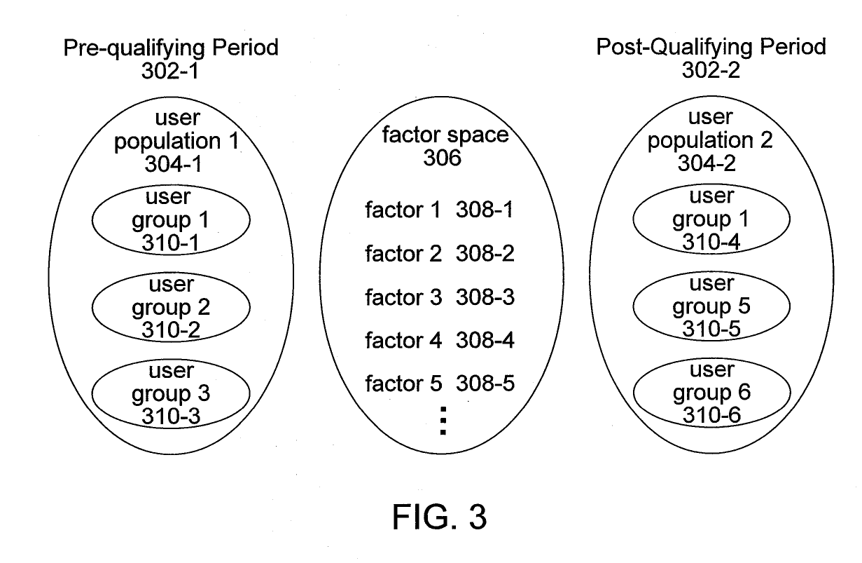

To illustrate how the discovery module (202) may be used to identify one or more candidate factors that have particular effects on user behaviors, reference will be made to FIG. 3 in the following discussion. For the purpose of illustration, user behaviors are frequencies of accesses made by users to a web page vertical. As used herein, a web page vertical may be, but is not limited to, one or more specific web sites, or a specific part of a web site, or one or more specific web pages. An example of a web page vertical may be, but is not limited to, one or more specific web pages such as Yahoo! Answers hosted on an internet server such as 106 of FIG. 1.

For the purpose of illustration, the above-mentioned particular effects, of interest to the discovery module (202), may be changes in frequencies (or intensities) of accesses made by users to the web page vertical. For example, the discovery module (202) may be used to identify factors that cause an increase in frequencies of accesses to Yahoo! Answers.

For the purpose of illustration, the factors may be intermediate pages users may have accessed between two time period: a pre-qualifying period and a post-qualifying period (302-1 and 302-2 of FIG. 3). As illustrated in FIG. 3, these factors, shown as 308-1 through 5 (dots shown in FIG. 3 indicate there may exist additional factors), may form a factor space 306. For the purpose of illustration, each of these factors (308-1 through 5) may be associated with an intermediate page users may have accessed between the pre-qualifying period and the post-qualifying period (302-1 and 302-2). In other words, the access to the intermediate page made by the users may or may not increase or decrease their access to the web page vertical in time period 2. In some embodiments, a time period where a factor 308 is exposed to users occurs in a qualifying period that is between the pre-qualifying period and the post-qualifying period.

User populations in the two periods 1 and 2 are depicted as user population 1 and user population 2 (304-1 and 304-2 of FIG. 3), respectively. Within each of the user populations, three user groups may be identified by the discovery module (202). For the purpose of illustration, the three user groups for user population 1 (304-1) in time period 1 are depicted as 1 through 3 (310-1 through 3 of FIG. 3); and the three user groups for user population 2 (304-2) in time period 2 are depicted as 4 through 6 (310-4 through 6).

### User Groups for Correlation Analysis

In accordance with some embodiments of the present description, user group 1 (310-1) are a set of users that access the web page vertical at a low engagement level (or intensity) in the pre-qualifying period (302-1). User group 4 (310-4) are a set of users that access the web page vertical at a low engagement level in the post-qualifying period (302-2). In some embodiments, the set of users in user group 1 is identical to the set of users in user group 4, and is called a baseline set of users. Thus, in these embodiments, the baseline set of users, in user groups 1 and 4, accesses the web page vertical at a low engagement level in both the pre-qualifying period and the post-qualifying period. The baseline set of users in user groups 1 and 4 may be identified by taking a set operation such as an intersection between a set of users who accesses the web page vertical at a low engagement level in the pre-qualifying period and another set of users who accesses the same page vertical at a low engagement level in the post-qualifying period.

In accordance with some embodiments of the present description, user group 2 (310-2) are a set of users that access the web page vertical at a low engagement level (or intensity) in the pre-qualifying period (302-1). User group 5 (310-5) are a set of users that access the web page vertical at a high engagement level in the post-qualifying period (302-2). In some embodiments, the set of users in user group 2 is identical to the set of users in user group 5, and is called a divergent set of users. Thus, in these embodiments, the divergent set of users, in user groups 2 and 5, accesses the web page vertical at a low engagement level in the pre-qualifying period but accesses the same vertical at a high engagement level in the post-qualifying period. The divergent set of users in user groups 2 and 5 may be identified by taking a set operation such as an intersection between a set of users who accesses the web page vertical at a low engagement level in the pre-qualifying period and another set of users who accesses the same page vertical at a high engagement level in the post-qualifying period.

In accordance with some embodiments of the present description, user group 3 (310-3) are a set of users that access the web page vertical at a high engagement level (or intensity) in the pre-qualifying period (302-1). User group 6 (310-6) are a set of users that access the web page vertical at a low engagement level in the post-qualifying period (302-2). In some embodiments, the set of users in user group 3 is identical to the set of users in user group 6, and is called an alternative divergent set of users. Thus, in these embodiments, the alternative divergent set of users, in user groups 3 and 6, accesses the web page vertical at a high engagement level in the pre-qualifying period but accesses the same vertical at a low engagement level in the post-qualifying period. The alternative divergent set of users in user groups 3 and 6 may be identified by taking a set operation such as an intersection between a set of users who accesses the web page vertical at a high engagement level in the pre-qualifying period and another set of users who accesses the same page vertical at a low engagement level in the post-qualifying period.

In some embodiments, more user groups may be defined. For example, two more user groups that share a set of identical users may be defined such that one user group accesses the web page vertical at a high engagement level in the pre-qualifying period and remains so in the post-qualifying period.

### Criteria

In some embodiments, a user in a user population such as user population 1 or 2 may be classified as a user with a high engagement level or a low engagement level based on certain criteria. For example, such a user population may be divided into one or more tiers. Users with a high engagement level may be those who access the web page vertical more frequently than 80% of a population. Similarly, users with a low engagement level may be those who access the same vertical less frequently than 80% of the population. The criteria that determine whether a user is considered as accessing the web page vertical criteria at a specific engagement levels may be configurable by a client of the automatic discovery and validation analyzer.

In some embodiments, once the criteria for a specific engagement level are set, a user group that is associated with the specific engagement level may be created by randomly selecting a portion of all users from a user population who match these set criteria.

### Identify Candidate Factors

For the purpose of illustration, the discovery module (202) may be interested in identifying candidate factors from a potentially huge number of possible factors 308 in the factor space (306) that have increased engagement of levels of some users in the user population over the time. To identify these candidate factors, in some embodiments, the discovery module (202) may only identify user groups 1, 2, 4 and 5 from their respective user populations. As previously explained, these four user groups may be made up of the baseline set of users and the divergent set of users who access the web page vertical in their respective levels in the pre-qualifying period and in the post-qualifying period.

In embodiments where factors 308 are associated with viewings of web pages between the pre-qualifying period and the post-qualifying period, the discovery module (202) may determine a number of accesses made by the baseline set of users, determines another number of accesses made by the divergent set of users, and then compare these two numbers of accesses to determine any points of inflection or any significant differences exhibited by users in the different sets of users.

TABLE 1

| | |
|---|---|
| (the baseline set of) | (the divergent set of) |
| users in | users in |
| user groups 1 and 4 | user groups 2 and 5 |

| Page ID | Page Views | Page ID | Page Views |
|---|---|---|---|
| 1 | 200,000 | 1 | 100,000 |
| 2 | 170,000 | 2 | 80,000 |
| 3 | 150,000 | 5 | 50,000 |
| 4 | 100,000 | 4 | 35,000 |
| 5 | 90,000 | 3 | 15,000 |

For example, factors 1-5 (308-1 through 5 of FIG. 3) may be associated with five distinct web pages. For the purpose of illustration, these five distinct web pages may be uniquely identified as Page ID 1 through 5 as illustrated in TABLE 1. Without loss of generality, factor 1 (308-1) may be associated with Page ID 1, factor 2 (308-2) may be associated with Page ID 2, and so on.

In some embodiments, the discovery module (202) may summarize a number of accesses made by the baseline set of users for each of the five distinct web pages associated with factors 1-5. Such numbers of accesses made by the baseline set of users in user for all of the five distinct web pages are summarily listed under a heading of “Page Views” in rows labeled 1 through 5 on a left-hand-side column in TABLE 1. Similarly, the discovery module (202) may summarize a number of accesses made by the divergent set of users for each of the five distinct web pages associated with factors 1-5. Such numbers of accesses made by the users in user groups 2 and 5 for all of the five distinct web pages are summarily listed under a heading of “Page Views” in rows labeled 1 through 5 on a right-hand-side column in TABLE 1.

### Points of Inflections

The discovery module (202) may determine a numeric order among the numbers of accesses made by users to these five distinct web pages. For instance, for the baseline set of users, the discovery module (202) may determine a numeric order among the numbers of accesses to these five distinct web pages. As shown on the left-hand-side columns in TABLE 1, a web page identified as Page ID 1 has 200,000 accesses from the users in user groups 1 and 4, another web page identified as Page ID 2 has 170,000 accesses from the same users, and so on. Likewise, as shown on the right-hand-side columns in TABLE 1, the web page identified as Page ID 1 has 100,000 accesses from the divergent set of users, the web page identified as Page ID 2 has 80,000 accesses from the same users, and so on.

The discovery module (202) may identify the numeric order in the numbers of accesses to the five distinct web pages for the baseline set of users as different from the numeric order in the numbers of accesses to the same pages for the divergent set of users. In particular, for the web page identified as Page ID 3, the number of accesses made by the baseline set of users in user groups 1 and 4 takes the 3^{rd} place in the numeric order of the left-hand-side of TABLE 1. However, for the same web page, the number of accesses made by the divergent set of users in user groups 2 and 5 takes the 5^{th} place in the numeric order of the right-hand-side of TABLE 1. Likewise, for the web page identified as Page ID 5, the number of accesses made by the users in user groups 1 and 4 takes the 5^{th} place in the numeric order of the left-hand-side of TABLE 1. However, for the same web page, the number of accesses made by the users in user groups 2 and 5 takes the 3^{rd} place in the numeric order of the right-hand-side of TABLE 1.

Thus, the web pages 3 and 5 may be identified by the discovery module (202) as associated with two inflection points in the numeric orders of the numbers of accesses to the five distinct web pages made by two different sets of users (i.e., a set of users in user groups 1 and 4, and another set of users in user groups 2 and 5). Consequently, factors 3 and 5 in the factor space may be identified as candidate factors that may have particular effects on user behaviors in accessing the web page vertical. This is because the baseline set of users in user groups 1 and 4 access the web page vertical in a low engagement level in both the pre-qualifying period and the post-qualifying period and exhibit a particular numeric order (or pattern) with respect to a set of web pages the users in user groups 1 and 4 are exposed to between the pre-qualifying period and the post-qualifying period, while the divergent set of users in user groups 2 and 5 access the web page vertical in measurably different engagement levels in the pre-qualifying period and the post-qualifying period and, incidentally or not so incidentally, exhibit a different numeric order (or pattern) with respect to a set of web pages than the particular numeric order (or pattern) the baseline set of users in user groups 1 and 4 are exposed to between the pre-qualifying period and the post-qualifying period.

In any event, these inflection points in numeric orders of numbers of accesses relative to these web pages associated with factors 108 may cause the discovery module (202) to identify these associated factors 108 as candidate factors that have particular effects on the user behaviors (i.e., changes in engagement levels by users relative to the web page vertical, which may or may not be the same as the pages associated with the factors 108). In some embodiments, these candidate factors are outputted to the validation module (204) for the purpose of determining whether any of the candidate factors is truly an impacting factor that causes changes in user behaviors.

### The Validation Process

In one embodiment, the validation process makes use of two contrasting sets of users and studies their behaviors in different time periods over an extended time period. In some embodiments, the extended period may be selected as the same as that used in the discovery process. As in the case of the discovery process, the validation process may use the same three time periods of a qualifying time period, a pre-qualifying period, and a the post-qualifying period.

In one embodiment, the validation process automatically identifies an “exposed” set of users, and an “unexposed” set of users. The exposed set of users are users that have been exposed to a candidate factor in the qualifying period, while under-exposed set of users are users that have not exposed to the candidate factor in the qualifying period. In the case where a candidate factor is viewing a particular web page, the exposed users may be selected as users that were exposed to the particular web page at least five times, for example. The unexposed set of users may be selected by the validation process on the basis that such users have not had the qualifying interaction. For example, the unexposed set of users may be users that have not been exposed to the particular web page five times. Other qualitatively and/or quantitatively different criteria may be used to select each of the two sets of users that are to be compared in the validation process. For example, the unexposed set of users may be users that have not been exposed to the particular web page at all while the exposed set of users may be users that have been exposed the particular web page for a certain configurable number of times.

Once the two contrasting sets of users are identified, the validation process may calculate an access metric for each set of users in each of the time periods before and after the qualifying period, as will be further explained in detail. From access metrics calculated, the validation process may detect relative changes between the users who are exposed to the candidate factor and the users who are not. In some embodiments, such relative changes filter out any overall, cumulative trend that may mask truly impacting factors. What is left after such filtering may be the true impact, if any, of the candidate factor that is under validation.

### Causation

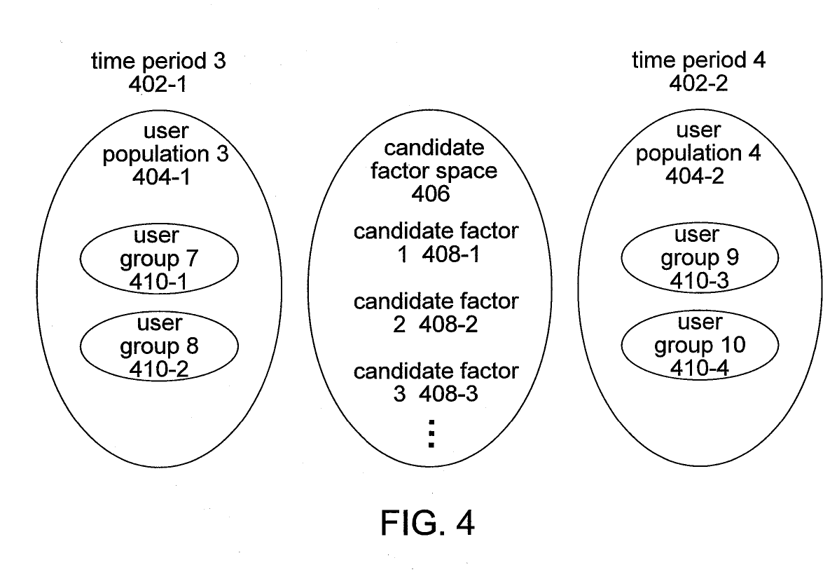

To illustrate how the validation module (204) may be used to determine (or validate) whether a candidate factor has a particular effect on user behaviors, reference will be made to FIG. 4 in the following discussion.

For the purpose of illustration, a candidate factor may be an intermediate page that the discovery module (202) has identified as related to an inflection point in user access pattern between two time period 3 and 4 (402-1 and 402-2 of FIG. 4). In some embodiments, the pre-qualifying period and the post-qualifying period (3 and 4) in FIG. 4 may be, but are not limited to be, identical to the pre-qualifying period and the post-qualifying period (302-1 and 2) in FIG. 3, respectively. For the purpose of exposition, time period 3 may be the pre-qualifying period while time period 4 may be the post-qualifying period.

As illustrated in FIG. 4, candidate factors, shown as 408-1 through 3 (dots shown in FIG. 4 indicate there may exist additional candidate factors), may form a candidate factor space 406. The access to an intermediate page (that corresponds to a candidate factor) made by users may or may not actually increase or decrease their access to the web page vertical in the post-qualifying period.

User populations in the pre-qualifying period and the post-qualifying period are depicted as user population 3 and user population 4 (404-1 and 404-2 of FIG. 4), respectively. In accordance with some embodiments of the present description, for each candidate factor, say a particular factor that is associated with an intermediate web page, within each of the user populations, two user groups may be identified by the validation module (204). For the purpose of illustration, the two user groups for user population 3 (304-1) in the pre-qualifying period are depicted as 7 and 8 (410-1 and 2 of FIG. 4); and the two user groups for user population 4 (404-2) in the post-qualifying period are depicted as 9 and 10 (410-3 and 4).

### User Groups for Causation Analysis

For the purpose of illustration, user group 7 (410-1) are an unexposed set of users in the pre-qualifying period (402-1) that accesses the web page vertical in that time period (i.e., the pre-qualifying period). User group 9 (410-3) are the same unexposed set of users in the post-qualifying period (402-2) that accesses the web page vertical in the post-qualifying period (402-2). The unexposed set of users in user groups 7 and 9 does not access, between the pre-qualifying period and the post-qualifying period (3 and 4), the intermediate web page that is associated with the particular candidate factor for which user groups 7-10 are selected.

For the purpose of illustration, user group 8 (410-2) are an exposed set of users in the pre-qualifying period (402-1) that accesses the web page vertical in that time period (i.e., the pre-qualifying period). User group 10 (410-3) are the same exposed set of users in the post-qualifying period (402-2) that accesses the web page vertical in the post-qualifying period (402-2). In contrast to the unexposed set of users, the exposed set of users in user groups 8 and 10 does access, between the pre-qualifying period and the post-qualifying period (3 and 4), the intermediate web page that is associated with the particular candidate factor for which user groups 7-10 are selected.

In some embodiments, the unexposed set of users in user groups 7 and 9 may be identified by taking a set operation such as an intersection between an initial (large) set of randomly selected users, who access the web page vertical in both the pre-qualifying period and the post-qualifying period, and a different set of randomized users, who does not access the intermediate web page in the qualifying period. Likewise, the exposed set of users in user groups 8 and 10 may be identified by taking a set operation such as an intersection between the initial (large) set of randomly selected users, who access the web page vertical in both the pre-qualifying period and the post-qualifying period, and another different set of randomized users, who does access the intermediate web page in the qualifying period.

### Test the Candidate Factor

For the purpose of illustration, the validation module (204) may be used to test whether an (identified) candidate factor 408 from in the candidate factor space (406) actually has a particular effect on user behaviors such as increasing engagement levels of those users who have been exposed to the candidate factor (408) between the pre-qualifying period and the post-qualifying period.

In embodiments where the candidate factor 408 is associated with viewings of a web page in the qualifying period, the validation module (204) may determine a number of accesses made by the unexposed set of users in user groups 7 and 9, determines another number of accesses made by the exposed set of users in user groups 8 and 10, and then compare these two numbers of accesses to determine whether there is any change in engagement levels between the two and, if that is the case, whether such a change is statistically significant enough to conclude that it is caused by the candidate factor.

In some embodiments, the validation module (204) tallies up accesses per group per user for each of user groups 7 through 10. For the purpose of illustration, user groups 7 and 9 (i.e., the unexposed set of users) may contain one hundred users. Each of the hundred users may access the web page vertical different numbers of times in any particular time period such as the pre-qualifying period or 4. For example, one of the hundred users may access the web page vertical 5 times in the pre-qualifying period and access the same vertical 8 times in the post-qualifying period; another of the hundred users may access the web page vertical 7 times in the pre-qualifying period and access the same vertical 4 times in the post-qualifying period; and so on. In any event, all the accesses made by the hundred users in the unexposed set of users will be summed up into a single number for each of the pre-qualifying period and the post-qualifying period. In particular, a single number of accesses made by all of the hundred users in the pre-qualifying period will be the total number of accesses by user group 7 while a single number of accesses made by all of the hundred users in the post-qualifying period will be the total number of accesses by user group 9.

Similarly, user groups 8 and 10 may contain more or fewer users than user groups 7 and 9. For the purpose of illustration, user groups 8 and 10 (i.e., the exposed set of users) may contain a comparable number to one hundred, say one hundred and ten. Each of the one hundred and ten users in user groups 8 and 10 may access the web page vertical different numbers of times in any particular time period such as the pre-qualifying period or 4. In any event, like user groups 7 or 9, all the accesses made by the hundred and ten users will be summed up into a single number for each of the pre-qualifying period and the post-qualifying period. In particular, a single number of accesses made by all of the hundred and ten users in the pre-qualifying period will be the total number of accesses by user group 8 while a single number of accesses made by all of the hundred and ten users in the post-qualifying period will be the total number of accesses by user group 10.

### Intensity Values

In some embodiments, an intensity value may be defined for each user group as an average number of accesses per user for that group. In other words, the intensity value for a group is a number of accesses made by all users of a user group divided by the number of the users in that user group. Thus, in some embodiments, the validation module (204) may determine four intensity values (say I(user group 7) for user group 7, I(user group 8) for user group 8, I(user group 9) for user group 9, and I(user group 10) for user group 10) for the four user groups (7 through 10).

In some embodiments, the validation module (204) contains statistical analysis capability. Thus, the validation module (204) may determine, for example, variances in accesses made by users of a user group to the web page vertical in a specific time period such as 3 and 4 here. The validation module (204) may look at the differences between the intensity levels and/or ratios between these intensity levels. The validation module (204) may also determine whether any difference in intensity levels is within a statistical variance or is statistically significant enough to conclude that the difference is caused by an exposure or a non-exposure to the web page associated with the candidate factor.

For example, the validation module (204) may calculate a first difference, for an earlier time period such as the pre-qualifying period, between the intensity values of user groups 7 and 8, i.e., I (user group 8)−I (user group 7). For simplicity, the first difference may be denoted as d (7-8). Correspondingly, the validation module (204) may then calculate a second difference, for a later time period such as the post-qualifying period, between the intensity values of user groups 9 and 10, i.e., I (user group 10)−I (user group 9). Again, for simplicity, this second difference may be denoted as d (9-10). In some embodiments, if the second difference in intensity values (corresponding to a later time period such as the post-qualifying period here) is significantly different from the first difference in intensity values (corresponding to an earlier time period such as the pre-qualifying period here), then the validation module (204) may determine that the candidate factor is a cause for an change in user engagement levels with respect to the web page vertical. On the other hand, if the second difference in intensity values varies with a reasonable statistical variance from the first difference in intensity values, then the validation module (204) may determine that the candidate factor is a not cause for an change in user engagement levels with respect to the web page vertical.

### Statistical Variance and Cause Validation

In some embodiments, as noted before, the validation module (204) may determine a statistical variance for each user group. For example, the validation module (204) may determine four variances, say σ(7) for user group 7, and σ(8) for user group 8, σ(9) for user group 9, and σ(10) for user group 10.

If the first difference is within a*σ(7)+b*σ(8), and if the second difference is not within c*σ(9)+d*σ(10), the validation module (204) may determine that the candidate factor is a cause for a change between the first difference (as between the intensity values of user groups 7 and 8) and the second difference (as between the intensity values of user groups 9 and 10). Here, a, b, c, and d may be configurable numeric factors. In some embodiments, all of these numeric factors may be set to be one. In some alternative embodiments, all of these numeric factors may be set to two. These and other values of the numeric factors (including different values for a, b, c and d) are within the scope of the present description.

If the first difference is not within a*σ(7)+b*σ(8), and if the second difference is within c*σ(9)+d*σ(10), the validation module (204) may determine that the candidate factor is a cause for an opposite change (relative to the change discussed above) between the first difference (as between the intensity values of user groups 7 and 8) and the second difference (as between the intensity values of user groups 9 and 10).

If the first difference is within a*σ(7)+b*σ(8), and if the second difference is within c*σ(9)+d*σ(10), the validation module (204) may determine that the candidate factor cannot be validated as a cause for any change between the first difference (as between the intensity values of user groups 7 and 8) and the second difference (as between the intensity values of user groups 9 and 10).

If the first difference is not within a*σ(7)+b*σ(8), and if the second difference is not within c*σ(9)+d*σ(10), the validation module (204) may determine that the candidate factor is validated as a cause for a change between the first difference (as between the intensity values of user groups 7 and 8) and the second difference (as between the intensity values of user groups 9 and 10), if such a change is significant. Otherwise, if such a change is not significant, the validation module (204) may determine that the candidate factor cannot be validated as a cause (factor).

### Score Values

In some embodiments, the validation process may be repeated for one or more additional candidate factors 408 in the candidate space (406). In some embodiments, the validation process may be repeated for all of the candidate factors (408) in the candidate space (406), using an iterative and/or recursive process. For example, candidate factor 1 (408-1) may be determined as not a cause with respect to the web page vertical such as Yahoo! Answers; candidate factors 2 and 3 (408-2 and 3) may be determined as a cause that changes user engagement levels with respect to the same vertical. In some embodiments, for each of the candidate factors that are determined as causes for change in user engagement levels with respect to the web page vertical (for example, candidate factors 2 and 3), the validation module (204) assigns a score value to indicate how strongly (impacting) such a candidate factor is in changing the user engagement levels with respect to the web page vertical. In some embodiments, this score value may be proportional to the above-mentioned second difference in intensity values, but may be inversely proportional to the above-mentioned first difference (if not zero) in intensity values (for example, the score value=(I(user group 10)−I(user group 9))/(I(user group 8)−I(user group 7))). In some other embodiments, this score value may be proportional to a difference between the above-mentioned second difference and the above-mentioned first difference in intensity values (for example, the score value=(I(user group 10)−I(user group 9))−(I(user group 8)−I(user group 7))).

As a result, for example, the validation module (204) may assign a value of 10.5 to candidate factor 2 while assign a value of −5.8 to candidate factor 3. That is, it may be concluded that candidate factor 2 has a positive effect in increasing user engagement levels with respect to Yahoo! Answers while candidate factor 3 has a negative effect in increasing user engagement levels. Thus, an owner of the web page vertical may use these score values to determine whether exposures (to a user population) of the web pages respectively associated with candidate factors 2 and 3 should be increased or decreased, depending on whether it is desirable to have any specific change in user engagement levels.

### Example Operation

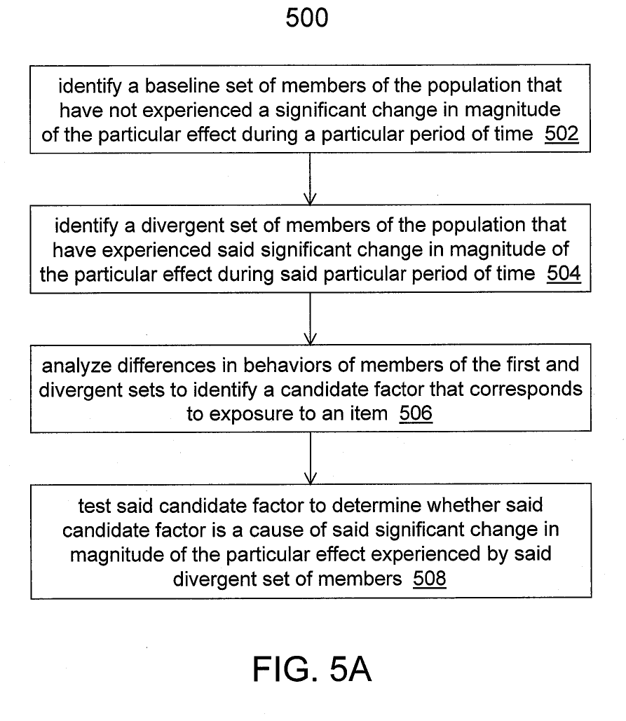

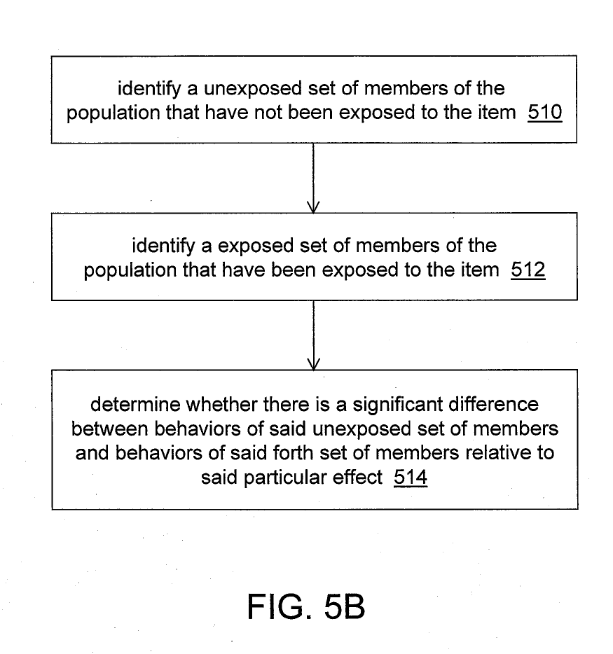

FIG. 5 is a flow diagram that illustrates an automatic discovery and validation process 500 for automatically determining factors that have a particular effect on members of a population, according to an embodiment of the present invention. In block 502, the automatic discovery and validation analyzer (102) identifies a baseline set of members of the population that have not experienced a significant change in magnitude of the particular effect during a particular period of time.

Here, the particular effect may be increased visits to a particular set of web pages such as the previously-mentioned web page vertical. The increased visits to the particular set of web pages, for a set of users, may be computed by the analyzer by taking the difference between a first number of visits (or accesses), made by the set of users to the particular set of web pages (e.g., the web page vertical), during an early time period (e.g., the pre-qualifying period 302-1 of FIG. 3) and a second number of visits, made by the same set of users to the particular set of web pages, during a later time period (e.g., the post-qualifying period 302-2 of FIG. 3). Both the early time period and the later time period can be two distinct time periods within said particular period of time in some embodiments. In a particular embodiment, the early time period and the later time period are completely non-overlapping with each other.

In some embodiments, the population may be an intersection of user populations 1 and 2 of FIG. 3. In these embodiments, the baseline set of members of the population may be the same as the set of users shared by user groups 1 and 4 (310-1 and 310-4 of FIG. 3). In a particular embodiment, a user in the baseline set of members of the population may be determined as on who remains at a specific engagement level relative to the particular set of web pages in the two distinct time periods within the particular period of time. Such time periods may, for example, be the pre-qualifying period and the post-qualifying period as illustrated in FIG. 3.

In a particular embodiment, the baseline set of members of the population may be identified by taking a set intersection operation between a set of users at a bottom 20% engagement level relative to the web page vertical in the pre-qualifying period of FIG. 3 and another set of users at a bottom 20% engagement level relative to the same vertical in the post-qualifying period of FIG. 3. Since a user in the baseline set of members of the population remains at a specific engagement level (i.e., the bottom 20%), for the purpose of this description, such a user is deemed to have not experienced a significant change in magnitude of the particular effect (for example, increased visits to the web page vertical) during the particular period of time.

In block 504, the automatic discovery and validation analyzer (102) identifies a divergent set of members of the population that have experienced the significant change in magnitude of the particular effect during the particular period of time.

In these embodiments where the population is the same as user population 1 (304-1) as illustrated in FIG. 3, the divergent set of members of the population may be the same as the set of users shared by user groups 2 and 5 (310-2 and 310-5 of FIG. 3). In a particular embodiment, a user in the divergent set of members of the population is determined as one who changes engagement levels relative to the particular set of web pages in the same two specific time periods within the particular period of time as the time periods previously described relative to the baseline set.

In a particular embodiment, the divergent set of members of the population may be identified by taking a set intersection operation between a set of users at a bottom 20% engagement level relative to the web page vertical in the pre-qualifying period of FIG. 3 and another set of users at a top 20% engagement level relative to the same vertical in the post-qualifying period of FIG. 3. Other less dramatic changes may be used to represent a significant change in magnitude of the particular effect. In some embodiments, the change in engagement levels of the users in the divergent set must be at least perceptible 1) above statistical noises and/or 2) apart from a general long term statistical trend unrelated to any specific factors 308 of FIG. 3 to which only a partial set of the population is exposed.

In block 506, the automatic discovery and validation analyzer (102) analyzes differences in behaviors of members of the baseline and divergent sets to identify a candidate factor that corresponds to exposure to an item. In a particular embodiment, the behaviors of the members of the baseline and divergent sets are measured by total numbers of exposures to the item by the members of the baseline and divergent sets. For example, if the item is an email advertisement, then the behaviors of the members of the baseline and divergent sets may be total numbers of exposures to the item by the members of the baseline and divergent sets. Similarly, if the item is represented by a web page which may or may not be related to the particular set of web pages (or the previously mentioned web page vertical), then the behaviors of the members of the baseline and divergent sets may be total numbers of accesses to the web page made by the members of the baseline and divergent sets. In some embodiments, as part of this analyzing step (i.e., 506 of FIG. 5), the automatic discovery and validation analyzer (102) considers one or more intermediate web pages accessed between the two distinct time periods such as the pre-qualifying period 302-1 and the post-qualifying period 302-2 of FIG. 3 as possible candidate factors, and determines individual numbers of accesses to these intermediate web pages by the members of the baseline and divergent sets (for example, users in user groups 1 and 4 of FIG. 3). The numbers of accesses to the intermediate web pages may be compared, as illustrated in TABLE 1. As previously described, inflection points and/or changes of numbers of accesses to the intermediate web pages may be determined. In some embodiments, these inflection points and/or changes may be identified as associated with candidate factors. Specifically, the candidate factor in step 506 may be determined as corresponding to exposure of one of the intermediate web pages. In some embodiments, behaviors that are used to identify candidate factors may occur in a qualifying period that is distinct from the two distinct time periods. In a particular embodiment where the two distinct time periods are non-overlapping, the qualifying period may be a period between the two distinct time periods that does not overlap with either of the two distinct time period.

In block 508, the automatic discovery and validation analyzer (102) tests the candidate factor to determine whether the candidate factor is a cause of the significant change in magnitude of the particular effect experienced by the divergent set of members.

FIG. 5B illustrates what steps may be employed by block 508 to test the identified candidate factor. Initially, two sets of members of a (user) population may be identified. In some embodiments, the population may be an intersection of user populations 3 and 4 of FIG. 4. In a particular embodiment, this population may be the same as the population that is used for the correlation analysis as illustrated in FIG. 5A. One of the two sets is an unexposed set of members. This set comprises a number of users that have not exposed to the item (which, for example, may be an intermediate web page during the qualifying period). The other of the two sets is an exposed set of members. In contrast to the unexposed set of members, this exposed set of members comprises a number of users that have exposed to the item (i.e., the intermediate web page in the present example). Thus, in blocks 510 and 512, the two sets are identified, respectively.

Once such two sets are identified relative to the candidate factor (or the item that corresponds to the candidate factor), in block 514, the validation module (204) determines whether there is a significant difference between behaviors of the two sets of members relative to the particular effect. For example, in embodiments where the particular effect is increased visit to the one or more web pages from one time period (for example, the pre-qualifying period of FIG. 3 or time period 3 of FIG. 4) to another time period (the post-qualifying period of FIG. 3 or time period 4 of FIG. 4), the validation module (204) may determine four metrics as previously described. Each of the four metrics represents a number of accesses to the one or more web pages by one of the two sets in each of the two periods. From these metrics, statistical analysis methods may be used by the validation module (204) to determine any changes in behaviors that are above statistical noise and/or apart from a general long-term trend of change. In particular, based on the statistical analysis methods, the validation module (204) may determine that the candidate factor is a cause for such changes in user behavior relative to the particular effect.

In some embodiments, in response to determining that the candidate factor is a cause of the significant change in magnitude of the particular effect, if such a significant change is desirable, system 100 may perform, or cause to perform, one or more actions to increase exposure of the population to the item. Alternatively, in response to determining that the candidate factor is a cause of the significant change in magnitude of the particular effect, if such a significant change is undesirable, system 100 may perform, or cause to perform, one or more actions to decrease exposure of the population to the item.

### Hardware Overview

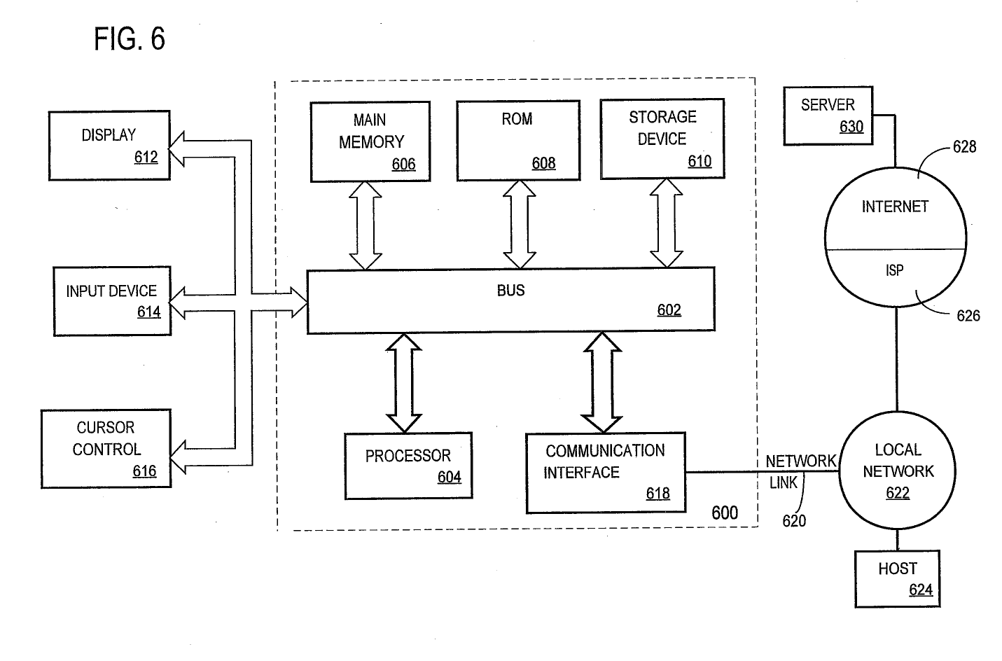

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may be used to implement the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for automatically determining factors that have a particular effect on members of a population, the method comprising:
identifying a baseline set of members of the population that have not experienced a significant change in magnitude of the particular effect during a particular period of time;
identifying a divergent set of members of the population that have experienced said significant change in magnitude of the particular effect during said particular period of time;
analyzing differences in behaviors of members of the baseline and divergent sets to identify a candidate factor that corresponds to exposure to an item; and
testing said candidate factor to determine whether said candidate factor is a cause of said significant change in magnitude of the particular effect experienced by said divergent set of members;
wherein said testing includes:
identifying a unexposed set of members of the population that have not been exposed to the item;
identifying a exposed set of members of the population that have been exposed to the item; and
determining whether there is a significant difference between behaviors of said unexposed set of members and behaviors of said forth set of members relative to said particular effect.

2. The method of claim 1, wherein the particular effect is increased visits to a particular set of web pages.

3. The method of claim 2, wherein the behaviors of said unexposed set of members and behaviors of said forth set of members relative to said particular effect are frequencies of visits to the particular set of web pages.

4. The method of claim 2, wherein the increased visits to the particular set of web pages is a difference between a first number of visits, to the particular set of web pages, made during an early time period and a second number of visits, to the particular set of web pages, made during a later time period, and wherein both the early time period and the later time period are within said particular period of time.

5. The method of claim 4, wherein said candidate factor corresponds to exposure to said item during a qualifying time period within said particular period of time.

6. The method of claim 5, wherein said qualifying period is different from said early time period and said later time period.

7. The method of claim 1, wherein the step of analyzing differences includes determining differences between exposures of members of the baseline set to said item and exposures of members of the divergent set to said item.

8. The method of claim 1 wherein said item is one or more web pages.

9. The method of claim 1, wherein the behaviors of the members of the baseline and divergent sets are measured by total numbers of exposures to said item by the members of the baseline and divergent sets.

10. The method of claim 1, further comprising, in response to determining that said candidate factor is a cause of said significant change in magnitude of the particular effect, performing one or more actions to increase exposure of said population to said item.

11. A computer-readable medium carrying one or more sequences of instructions which, when executed by one or more processors, causes the one or more processors to perform the method recited in claim 1.

12. A computer-readable medium carrying one or more sequences of instructions which, when executed by one or more processors, causes the one or more processors to perform the method recited in claim 2.

13. A computer-readable medium carrying one or more sequences of instructions which, when executed by one or more processors, causes the one or more processors to perform the method recited in claim 3.

14. A computer-readable medium carrying one or more sequences of instructions which, when executed by one or more processors, causes the one or more processors to perform the method recited in claim 4.

15. A computer-readable medium carrying one or more sequences of instructions which, when executed by one or more processors, causes the one or more processors to perform the method recited in claim 5.

16. A computer-readable medium carrying one or more sequences of instructions which, when executed by one or more processors, causes the one or more processors to perform the method recited in claim 6.

17. A computer-readable medium carrying one or more sequences of instructions which, when executed by one or more processors, causes the one or more processors to perform the method recited in claim 7.

18. A computer-readable medium carrying one or more sequences of instructions which, when executed by one or more processors, causes the one or more processors to perform the method recited in claim 8.

19. A computer-readable medium carrying one or more sequences of instructions which, when executed by one or more processors, causes the one or more processors to perform the method recited in claim 9.

20. A computer-readable medium carrying one or more sequences of instructions which, when executed by one or more processors, causes the one or more processors to perform the method recited in claim 10.
